(19) United States
(12) Patent Application Publication
(10) Pub. No.: US 2016/0064033 A1
(43) Pub. Date: Mar. 3, 2016

(54) PERSONALIZED AUDIO AND/OR VIDEO SHOWS

(71) Applicant: Microsoft Corporation, Redmond, WA (US)

(72) Inventors: Anirudh Koul, Sunnyvale, CA (US); Meher Anand Kasam, Sunnyvale, CA (US); Yoeryoung Song, Santa Clara, CA (US)

(21) Appl. No.: 14/468,892

(22) Filed: Aug. 26, 2014

(51) Int. Cl. G11B 27/031; G10L 25/57; G10L 15/18

(52) U.S. Cl. CPC G11B 27/031; G10L 15/18; G10L 25/57

(57) ABSTRACT

One or more techniques and/or systems are provided for providing personalized audio shows and/or video shows. For example, content corresponding to an interest of a user may be identified (e.g., a videogame article, a home renovation blog, etc.). One or more actor templates within a natural language template set may be applied to portions of the content to create audio snippets. For example, text-to-speech synthesis functionality may use a first actor template to convert the videogame article into a videogame snippet and may use a second actor template to convert the home renovation blog into a home renovation snippet. The videogame snippet and the home renovation snippet may be used to generate an audio show (e.g., a dialogue between a first actor persona, defined within the first actor template, reading the videogame snippet and a second actor persona, defined within the second actor template, reading the home renovation snippet).

### BACKGROUND

Many users may obtain information through computing devices. In an example, a user may route driving directions using a vehicle navigation system. In another example, a user may experience music, movies, videogames, and/or other content through various types of devices, such as a videogame system, a tablet, a smart phone, etc.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for providing personalized audio shows and/or video shows are provided. Content corresponding to an interest of a user may be identified. A natural language template set to apply to the content may be selected. The natural language template set may define a first actor template. The first actor template may be utilized to convert a first portion of the content into a first audio snippet. An audio show comprising the first audio snippet may be generated. The audio show may be provided to the user.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of providing personalized audio shows.

FIG. 2 is a component block diagram illustrating an exemplary system for providing personalized audio shows.

FIG. 3 is a component block diagram illustrating an exemplary system for providing personalized audio shows based upon generated content.

FIG. 4 is a component block diagram illustrating an exemplary system for providing personalized audio shows based upon historical travel data of a user.

FIG. 5 is a component block diagram illustrating an exemplary system for generating a new actor template.

FIG. 6 is a flow diagram illustrating an exemplary method of providing personalized video shows.

FIG. 7 is an illustration of an example of providing a video show to a user through a computing device.

FIG. 8 is an illustration of an exemplary computer readable medium wherein processor-executable instructions configured to embody one or more of the provisions set forth herein may be comprised.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more techniques and/or systems for providing personalized audio shows and/or video shows are provided herein. Content that may be interesting to a user may be identified (e.g., videogame articles, marathon blogs, etc.). One or more actor templates, within a natural language template set, may be utilized to convert portions of the content into audio snippets. An actor template may comprise vocal characteristics and/or parameters that may be utilized by text-to-speech synthesis. The audio snippets may be assembled into an audio show and/or used to generate a video show. The audio show and/or the video show may be provided to the user. In an example, an audio show generation component may be hosted by a server that is remote from a device associated with the user, such that audio shows may be streamed to the device. In another example, the audio show generation component may be hosted locally on the device, such that audio shows may be generated locally on the device for the user.

Accordingly, while content does exist for a user to consume (e.g., radio newscasts, talk shows, etc.), such content is not personalized for the user. Existing content may or may not be of interest to the user (e.g., the user may continually change radio stations when driving to find content that may be of interest to the user). Additionally, existing content, broadcasts, etc. do not consider the time the user has to consume such content (e.g., a talk show may begin to discuss a topic that is of interest to the user just as the user arrives at work and thus the user may not be able to consume such content). As provided herein, an audio show and/or video show is generated that is personalized for the user and thus likely to comprise content that is of interest to the user. Moreover, a duration of the audio and/or video show is tailored based upon the time the user has to consume such content (e.g., a 20 minute audio show is generated in real time or on the fly when the user is perceived as embarking on a 20 minute commute to work). The user is thus presented with (e.g., fresh) content that is highly likely to be of interest to the user for a duration that allows the user to consume such content. Such content may or may not have commercials. If such content, does have commercials, however, such commercials may describe products and/or services likely relevant to and/or of interest to the user (e.g., advertisement for running shoes may be played in association with audio snippet of a running blog that is being read to the user). The user may thus find such commercials more useful (e.g., less distracting) than randomly broadcast commercials and/or commercials that are targeted to a particular “drive time” demographic, for example.

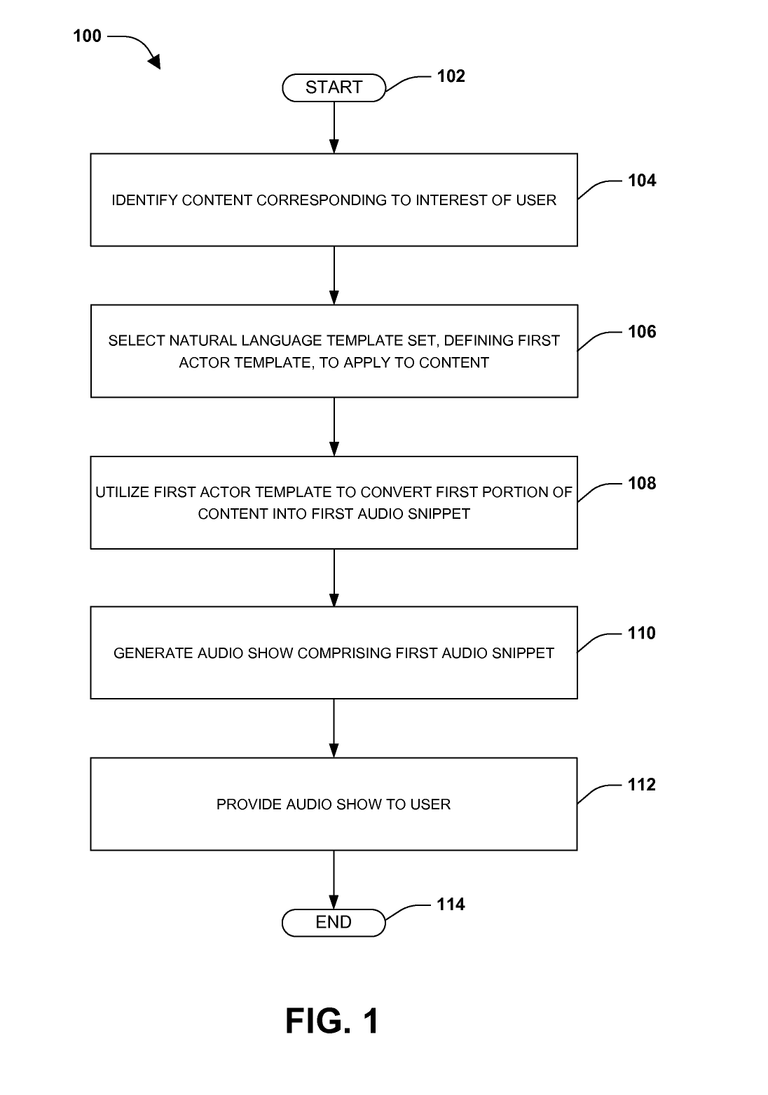

An embodiment of providing personalized audio shows is illustrated by an exemplary method 100 of FIG. 1. At 102, the method starts. A user may be identified as having various interests that may be used to identify content to selectively provide to the user. For example, a calendar of the user, a social network profile of the user, a user location (e.g., a videogame convention), web browsing history of the user, a user data file (e.g., a videogame console receipt), user demographic data, user cultural data, a user specified interest, and/or a variety of other content sources may be evaluated to identify one or more interests of the user. The user may take affirmative action to allow access to various content sources that may be evaluated to identify interests of the user. For example, a user may provide opt-in consent to allow access to and/or use of historical and/or real-time data, such as for the purpose of identifying interests of the user (e.g., where the user responds to a prompt regarding the collection and/or use of such information).

At 104, content corresponding to the interest of the user may be identified. In an example, social network data associated with the user may be evaluated to identify a videogame interest of the user, such as based upon one or more posts regarding one or more videogames (e.g., listing scores, strategies, commentary, etc.). Accordingly, content such as a videogame article may be identified based upon the videogame interest. In another example, a calendar associated with the user may be evaluated to identify a marathon interest of the user, such as based upon one or more marathon related entries within the calendar (e.g., training days listed within the calendar). Accordingly, second content such as a marathon blog may be identified based upon the marathon interest. In an example, the content is associated with a topic and/or category (e.g., gaming for the videogame interest, marathons for the marathon interest, etc.). The topic and/or category may allow advertisements that are likely to be relevant and/or of interest to the user to be obtained for presentation to the user.

At 106, a natural language template set may be selected to apply to the content, the second content, and/or other content corresponding to interests of the user (e.g., a language and/or user preference, such as a preference for female voices, robot voices, cartoon voices, fast or slow voices, etc., may be used to select the natural language template set). The natural language template set may define one or more actor templates. For example, the natural language template set may define a first actor template defining a first actor persona (e.g., a first set of audio parameters and/or characteristics utilized by the text-to-speech synthesis functionality) and a second actor template defining a second actor persona (e.g., a second set of audio parameters and/or characteristics utilized by the text-to-speech synthesis functionality).

At 108, the first actor template may be utilized (e.g., by the text-to-speech synthesis functionality) to convert a first portion of the content into a first audio snippet. For example, the first actor template may be used to convert at least some of the videogame article into a videogame article audio snippet (e.g., tittle, summary, abstract, entire article, etc. of videogame article into videogame audio snippet). In an example, the second actor template may be used to convert at least some of the marathon blog into a marathon blog audio snippet. A dialogue may be facilitated between the first actor persona, speaking the videogame article audio snippet, and the second actor persona speaking the marathon blog audio snippet (e.g., a first name may be assigned to the first actor persona and a second user name may be assigned to the second actor persona, such that the actor personas may reference one another during the dialogue using the assigned names). In an example, a tone of the content may be identified, and an audio characteristic may be applied to an actor template based upon the tone (e.g., a pitch of the second actor persona may be increased to indicate a positive sentiment/tone of the marathon blog). In this way, one or more audio snippets may be generated.

At 110, an audio show comprising the first audio snippet and/or other audio snippets may be generated (e.g., with or without commercials). In an example, an audio show playtime for the audio show may be identified. For example, historical travel data for the user may be evaluated to identify an estimated commute time for a current commute of the user (e.g., time and/or location data may be evaluated to determine that the user is driving from home to work, which likely corresponds to a 45 minute commute based upon current traffic conditions and/or historical travel data). The estimated commute time for the current commute may be used to identify the audio show playtime. Playtimes of one or more audio snippets may be identified based upon read speed metrics of actor templates (e.g., words per minute of actor personas) used to generate such audio snippets. At least some of the one or more audio snippets may be selectively included within the audio show such that a combined playtime of the included audio snippets corresponds to the audio show playtime (e.g., about 45 minutes of audio snippets may be included within the audio show for the user's commute).

At 112, the audio show may be provided to the user. In an example, the audio show may be played through a videogame console, a vehicle sound system, a mobile device, and/or any other computing device. In an example, a video show may be generated based upon the audio show. For example, the first actor persona may be rendered to speak the first audio snippet and the second actor persona may be rendered to speak the second audio snippet. The video show may be provided to the user (e.g., displayed on a computing device of the user).

In an example, interaction of the user with the audio show may be evaluated to generate user feedback (e.g., the user may skip the marathon blog audio snippet, may routinely fast forward through stock quote parts of articles, etc.). The interests of the user may be adjusted based upon the user feedback. For example, the marathon interest and/or stock quotes in general may be assigned a lower relevance weight or may be removed as an interest for the user. In this way, personalized audio shows and/or video shows may be automatically provided to the user and/or the content of such shows may be dynamically updated over time. At 114, the method ends.

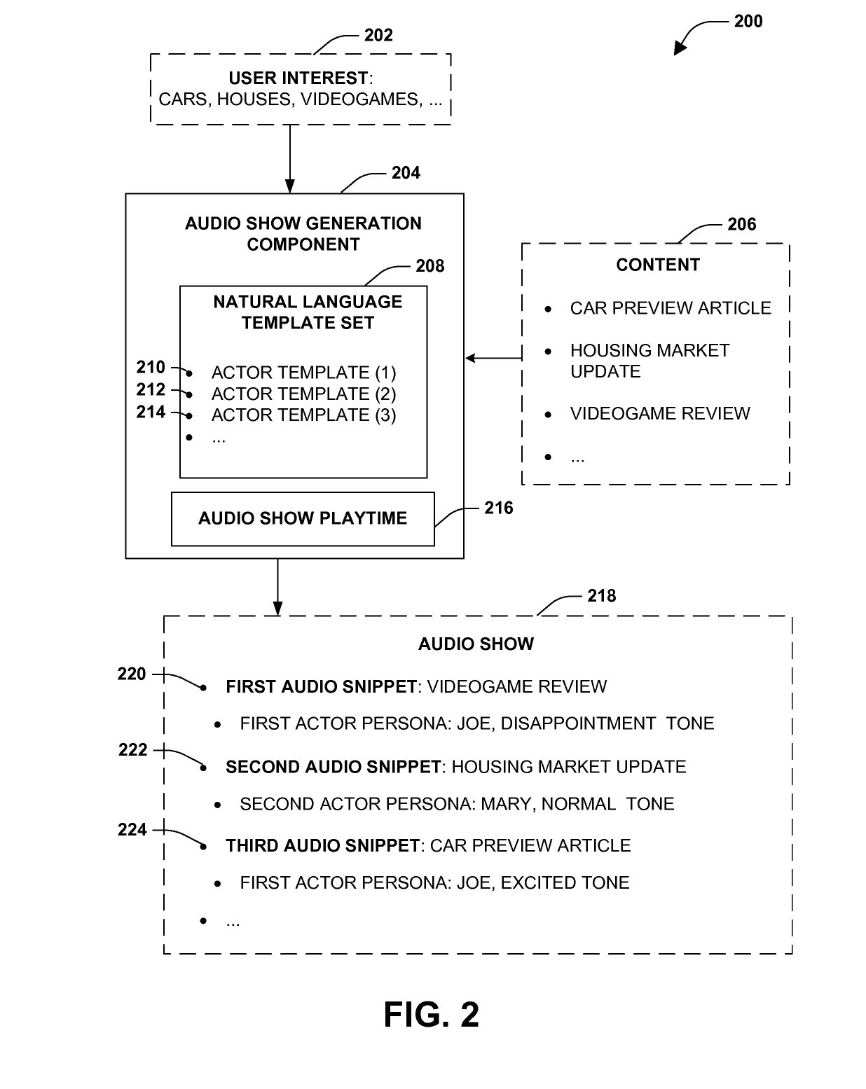

FIG. 2 illustrates an example of a system 200 for providing personalized audio shows. The system 200 comprises an audio show generation component 204. The audio show generation component 204 may be configured to identify content 206 corresponding to an interest 202 of a user. For example, a car preview article, a housing market update, a videogame review, and/or other content may be identified based upon the interest 202 in cars, houses, videogames, etc. The audio show generation component 204 may select a natural language template set 208 comprising a first actor template 210 defining a first actor persona, a second actor template 212 defining a second actor persona, a third actor template 214 defining a third actor persona, and/or other actor templates that may comprise audio parameters and/or characteristics utilized by text-to-speech synthesis functionality to create audio snippets from the content 206.

The audio show generation component 204 may utilize one or more of the actor templates to convert portions of the content 206 into audio snippets. For example, the first actor template 210 may be used to convert the videogame review into a first audio snippet 220 where the first actor persona is assigned a name Joe and is configured to have a disappointment tone when reading the videogame review (e.g., a decreased pitch audio characteristic may be applied to indicate disapproval of a videogame). The second actor template 212 may be used to convert the housing market update into a second audio snippet 222 where the second actor persona is assigned a name Mary and is configured to have a normal tone when reading the housing market update. The first actor template 210 may be used to convert the car preview article into a third audio snippet 224 where the first actor persona, assigned the name Joe, is configured to have an excited tone when reading the car preview article (e.g., an increased pitch audio characteristic may be applied to indicate excitement about a car).

The audio show generation component 204 may generate an audio show 218 comprising one or more of the audio snippets. For example, the first audio snippet 220, the second audio snippet 222, the third audio snippet 224, and/or other audio snippets may be included within the audio show 218 based upon an audio show playtime 216 (e.g., the audio show 218 may comprise audio snippets having a combined playtime corresponding to the audio show playtime 216). The audio show 218 may be provided to the user. For example, the first actor persona and the second actor persona may speak through various audio snippets as a dialogue (e.g., the actor personas may refer to one another as Joe and Mary, similar to a news broadcast dialogue).

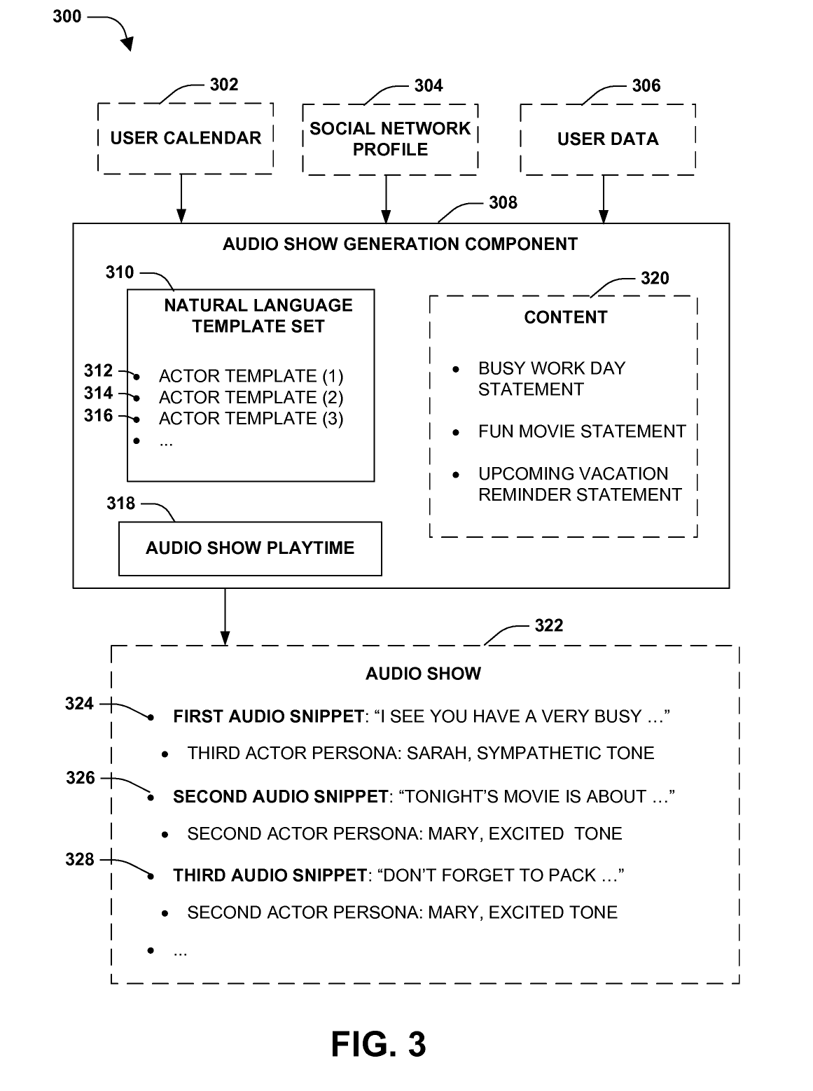

FIG. 3 illustrates an example of a system 300 for providing personalized audio shows based upon generated content. The system 300 comprises an audio generation component 308. The audio generation component 308 may be configured to identify content 320 corresponding to an interest of a user. For example, the audio generation component 308 may identify (e.g., generate) a busy work data statement based upon a user calendar 302 indicating that the user has a long work day full of scheduled meetings, where the schedule is of interest to the user by virtue of being on the user calendar. The audio generation component 308 may identify (e.g., generate) a fun movie statement based upon a social network profile 304 indicating that the user is going to the movies tonight, where the movie attendance is of interest to the user by virtue of being an entry in the social network profile of the user. The audio generation component 308 may identify (e.g., generate) an upcoming vacation reminder statement based upon user data 306 comprising a travel itinerary document, where the vacation is of interest to the user by virtue of being comprised in the user data. The audio generation component 308 may select a natural language template set 310 comprising a first actor template 312 defining a first actor persona, a second actor template 314 defining a second actor persona, a third actor template 316 defining a third actor persona, and/or other actors templates that may comprise audio parameters and/or characteristics utilized by text-to-speech synthesis functionality to create audio snippets from the content 320.

The audio show generation component 308 may utilize one or more of the actor templates to convert portions of the content 320 into audio snippets. For example, the third actor template 316 may be used to convert the busy work day statement into a first audio snippet 324 where the third actor persona is assigned a name Sarah and is configured to have a sympathetic tone when reading the busy work day statement. The second actor template 314 may be used to convert the fun movie statement into a second audio snippet 326 where the second actor persona is assigned a name Mary and is configured to have an excited tone when reading the fun movie statement. The second actor template 314 may be used to convert the upcoming vacation reminder statement into a third audio snippet 328 where the second actor persona, assigned the name Mary, is configured to have the excited tone when reading the upcoming vacation statement.

The audio show generation component 308 may generate an audio show 322 comprising one or more of the audio snippets. For example, the first audio snippet 324, the second audio snippet 326, the third audio snippet 328, and/or other audio snippets may be included within the audio show 322 based upon an audio show playtime 318 (e.g., the audio show 322 may comprise audio snippets having a combined playtime corresponding to the audio show playtime 318). The audio show 322 may be provided to the user. For example, the third actor persona and the second actor persona may speak through various audio snippets as a dialogue (e.g., the actor personas may refer to one another as Sarah and Mary, similar to a news broadcast dialogue).

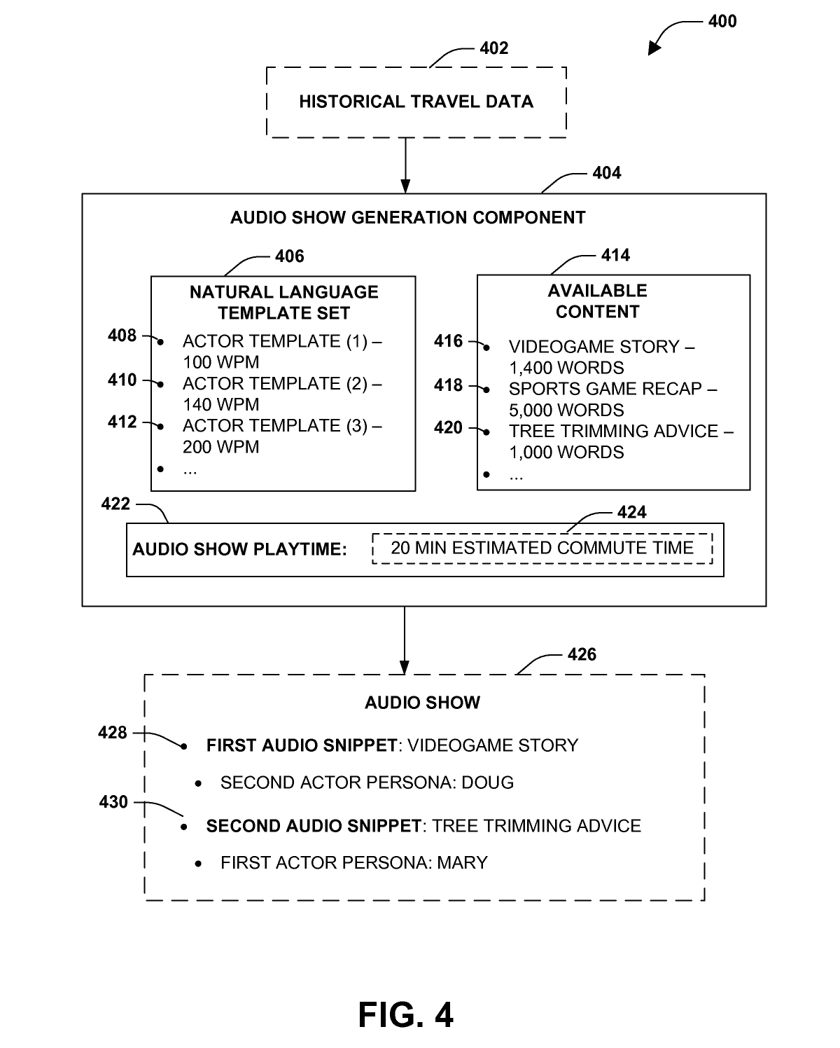

FIG. 4 illustrates an example of a system 400 for providing personalized audio shows based upon historical travel data 402 of a user. The system 400 comprises an audio show generation component 404. The audio show generation component 404 may evaluate the historical travel data 402 to identify an estimated commute time 424 (e.g., 20 minutes) for a current commute of the user. For example, the historical travel data 402 may indicate that prior commute times of the user from home to work usually take about 20 minutes (e.g., under certain traffic, weather, etc. conditions). Current time and/or location data may be evaluated to determine that the user is going to commute from home to work (e.g., under similar traffic, weather, etc. conditions). Accordingly, the estimated commute 424 of 20 minutes may be identified and assigned to the audio show playtime 422.

The audio show generation component 404 may selectively utilize one or more actor templates within a natural language template set 406 to convert one or more portions of content to generate an audio show 426 having a playtime corresponding to the audio show playtime 422 (e.g., so that the user may listen to the audio show 426 during the estimated 20 minute commute from home to work). For example, the natural language template set 406 may define a first actor template 408 with a first actor persona having a 100 word per minute speech rate, a second actor template 410 with a second actor persona having a 140 word per minute speech rate, and a third actor template 412 with a third actor persona having a 200 word per minute speech rate. Available content 414 may comprise a videogame story 416 comprising 1,400 words, a sports game recap comprising 5,000 words, and tree trimming advice 420 having 1,000 words. The audio show generation component 404 may selectively apply the second actor template 410 to the videogame story 416 to create a first audio snippet 428, and may selectively apply the first actor template 408 to the tree trimming advice 420 to create a second audio snippet 430, where the first actor persona is assigned a name Mary and the second actor persona is assigned the name Doug. The audio show generation component 404 may include the first audio snippet 428 and the second audio snippet 430 within the audio show 426 based upon the first audio snippet 428 and the second audio snippet 430 having a combined playtime corresponding to the audio show playtime 422. In this way, the audio show 426 may be provided to the user during the current commute from home to work.

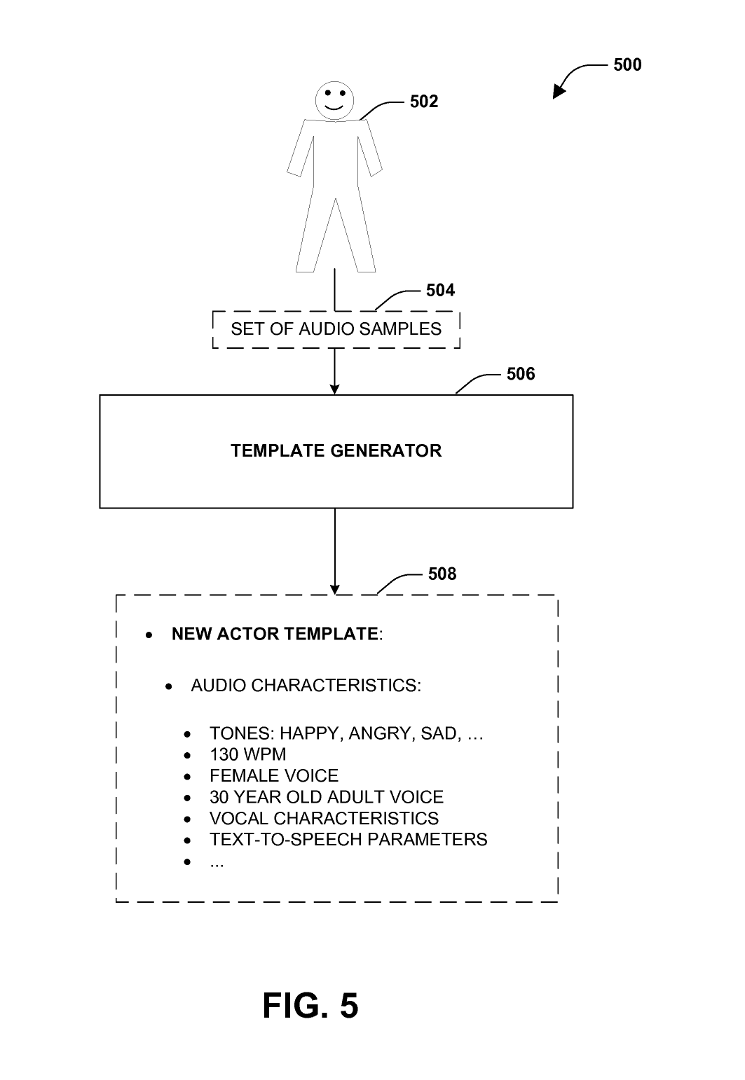

FIG. 5 illustrates an example of a system 500 for generating a new actor template 508. The system 500 comprises a template generator 506. The template generator 506 may be configured to evaluate a set of audio samples 504 of person 502 (e.g., a community of users may vote on the person 502 as having a voice that would be desirable for users to hear (e.g., the voice of a celebrity, politician, newscaster, athlete, businessperson, etc.). The template generator 506 may evaluate the set of audio samples 504 to generate a set of audio characteristics (e.g., tone, sound samples, voice characteristics, rate of speech, input parameters for text-to-speech synthesis, etc.) that may be used by text-to-speech synthesis functionality to create a computer generated audio snippet of content sounding as though the person 502 read the content. In this way, the template generator 506 may generate the new actor template 508 for the person 502.

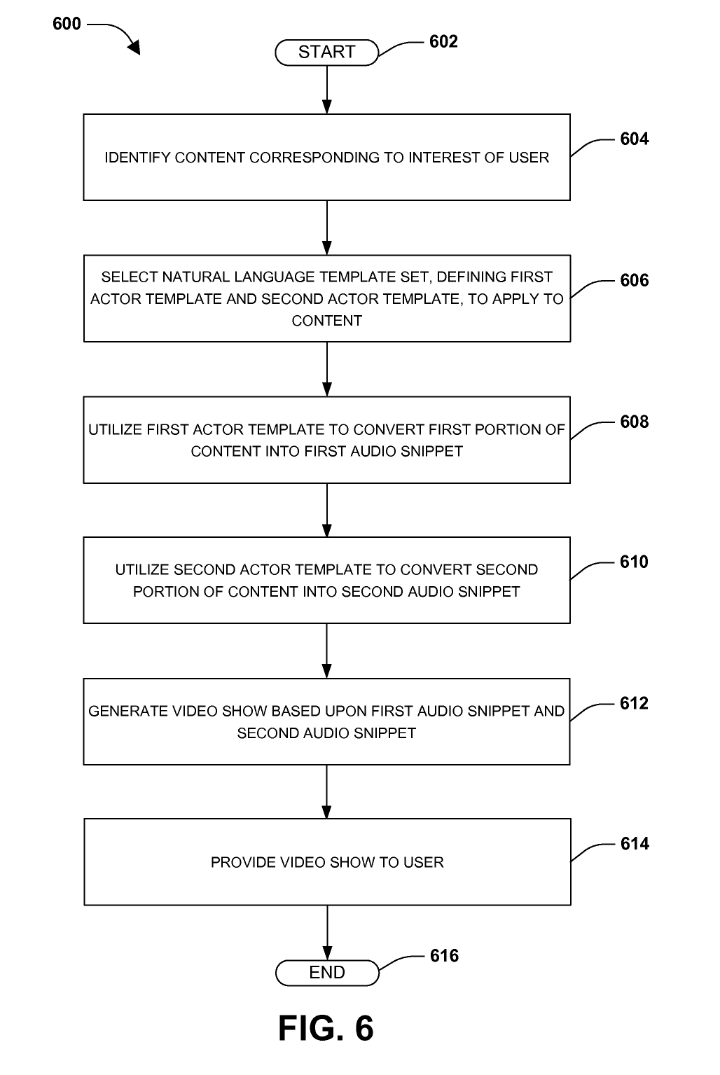

An embodiment of providing personalized video shows is illustrated by an exemplary method 600 of FIG. 6. At 602, the method starts. At 604, content corresponding to an interest of a user may be identified (e.g., a videogame console release article, a videogame review blog, etc.). At 606, a natural language template set may be selected to apply to the content. The natural language template set may define a first actor template and a second actor template. At 608, the first actor template may be utilized to covert a first portion of the content, such as at least some of the videogame console release article, into a first audio snippet. At 610, the second actor template may be utilized to convert a second portion of the content, such as at least some of the videogame review blog, into a second audio snippet. At 612, a video show may be generated based upon the first audio snippet and the second audio snippet. For example, a first actor persona, defined within the first actor template, may be rendered to speak the first audio snippet. A second actor persona, defined within the second actor template, may be rendered to speak the second audio snippet. In an example, the first actor persona and the second actor persona may speak the audio snippets as a dialogue. At 616, the video show may be provided to the user (e.g., played on a computing device of the user).

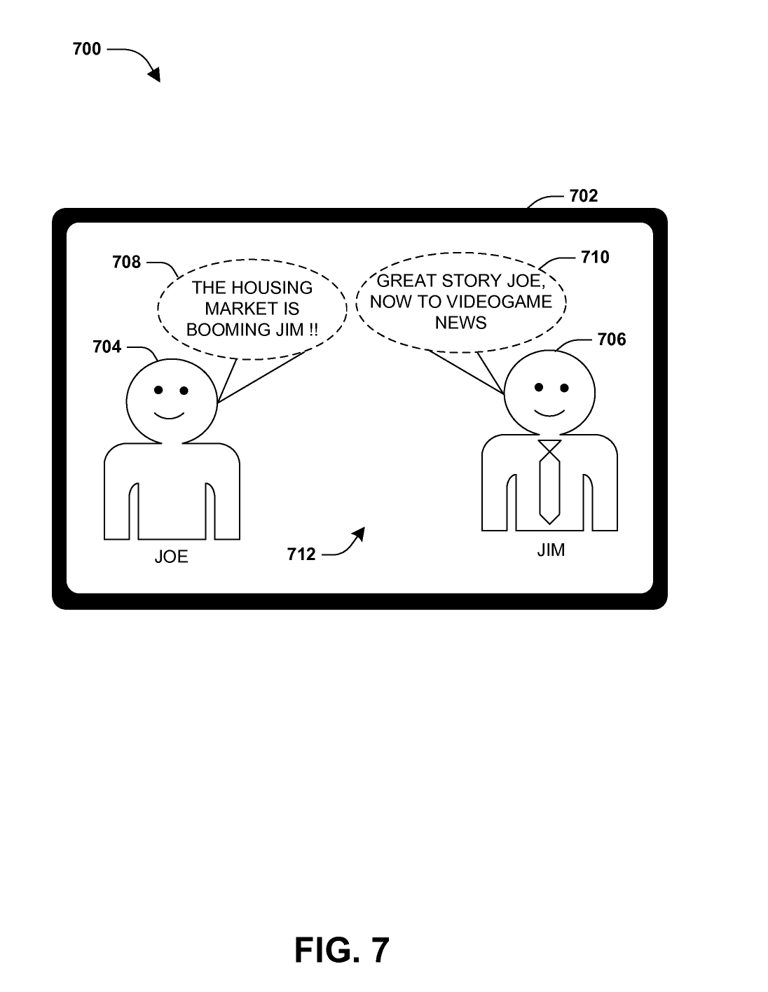

FIG. 7 illustrates an example 700 of providing a video show 712 to a user through a computing device 702. A first actor persona 704 and a second actor persona 706 may be rendered within the video show 712. The first actor persona 704 may be assigned a name Joe, and may be configured to speak a first audio snippet 708 (e.g., text-to-speech synthesis may be used to generate the first audio snippet 708 based upon first content corresponding to a first interest of the user, such as a housing market blog). The second actor persona 706 may be assigned a name Jim, and may be configured to speak a second audio snippet 710 (e.g., text-to-speech synthesis may be used to generate the second audio snippet 710 based upon second content corresponding to a second interest of the user, such as a videogame news story). The first actor persona 704 may be configured to refer to the second actor persona 706 as Jim. The second actor persona 706 may be configured to refer to the first actor persona 704 as Joe. In this way, the video show 712 may be provided as a dialogue. It will be appreciated that the first actor persona and/or the second actor persona may respectively be based upon (e.g., resemble, sound like, etc.) a celebrity, newscaster, sports announcer, etc.

According to an aspect of the instant disclosure, a method for providing personalized audio shows is provided. The method includes identifying content corresponding to an interest of a user. A natural language template set may be selected to apply to the content. The natural language template set may define a first actor template. The first actor template may be utilized to convert a first portion of the content into a first audio snippet. An audio show, comprising the first audio snippet, may be generated. The audio show may be provided to the user.

According to an aspect of the instant disclosure, a system for providing personalized audio shows is provided. The system includes an audio show generation component. The audio show generation component may be configured to identify content corresponding to an interest of a user. The audio show generation component may select a natural language template set to apply to the content. The natural language template set may define a first actor template and a second actor template. The audio show generation component may utilize the first actor template to convert a first portion of the content into a first audio snippet. The audio show generation component may utilize the second actor template to convert a second portion of the content into a second audio snippet. The audio show generation component may generate an audio show comprising the first audio snippet and the second audio snippet. The audio show generation component may provide the audio show to the user.

According to an aspect of the instant disclosure, a method for providing personalized video shows is provided. The method includes identifying content corresponding to an interest of a user. A natural language template set may be selected to apply to the content. The natural language template set may define a first actor template and a second actor template. The first actor template may be utilized to convert a first portion of the content into a first audio snippet. The second actor template may be utilized to convert a second portion of the content into a second audio snippet. A video show, comprising the first audio snippet and the second audio snippet, may be generated such that a first actor persona is rendered to speak the first audio snippet and a second actor persona is rendered to speak the second audio snippet. The video show may be provided to the user.

According to an aspect of the instant disclosure, a means for providing a personalized audio show and/or a personalized video show may identify content corresponding to an interest of a user. The means for providing may select a natural language template to apply to the content, where the natural language template set may define a first actor template and a second actor template. The first actor template may be utilized to convert a first portion of the content into a first audio snippet. The second actor template may be utilized to convert a second portion of the content into a second audio snippet. The means for providing may generate an audio show and/or a video show comprising the first audio snippet and the second audio snippet, and provide the same to the user.

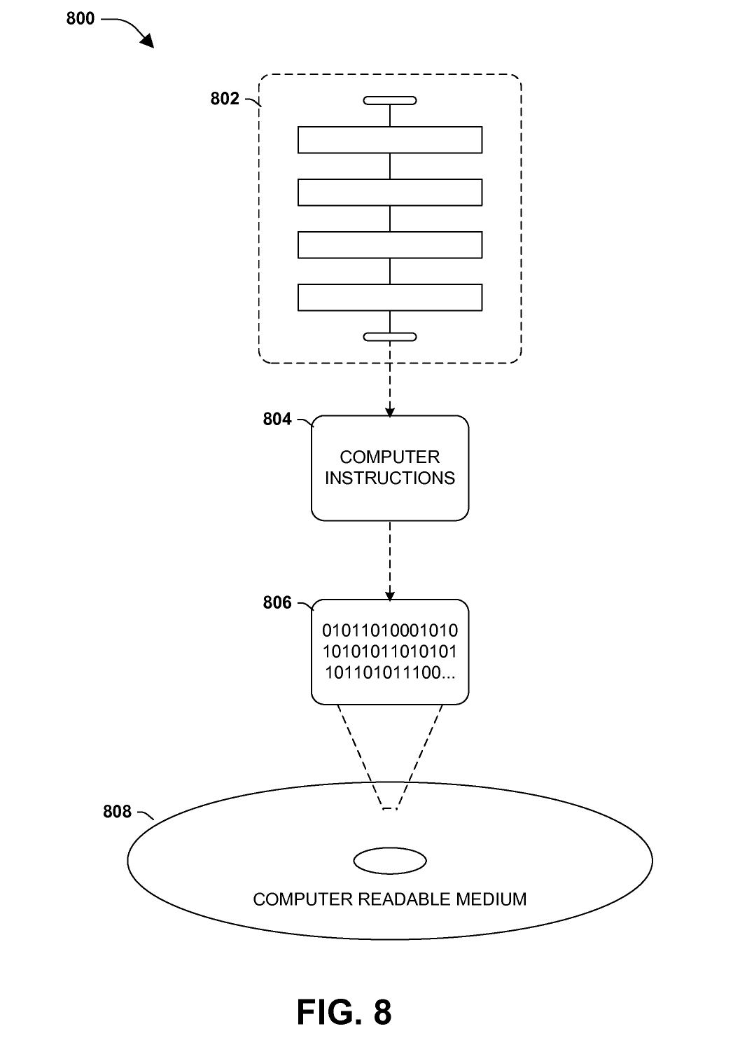

Still another embodiment involves a computer-readable medium comprising processor-executable instructions configured to implement one or more of the techniques presented herein. An example embodiment of a computer-readable medium or a computer-readable device is illustrated in FIG. 8, wherein the implementation 800 comprises a computer-readable medium 808, such as a CD-R, DVD-R, flash drive, a platter of a hard disk drive, etc., on which is encoded computer-readable data 806. This computer-readable data 806, such as binary data comprising at least one of a zero or a one, in turn comprises a set of computer instructions 804 configured to operate according to one or more of the principles set forth herein. In some embodiments, the processor-executable computer instructions 804 are configured to perform a method 802, such as at least some of the exemplary method 100 of FIG. 1 and/or at least some of the exemplary method 600 of FIG. 6, for example. In some embodiments, the processor-executable instructions 804 are configured to implement a system, such as at least some of the exemplary system 200 of FIG. 2, at least some of the exemplary system 300 of FIG. 3, at least some of the exemplary system 400 of FIG. 4, and/or at least some of the exemplary system 500 of FIG. 5, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

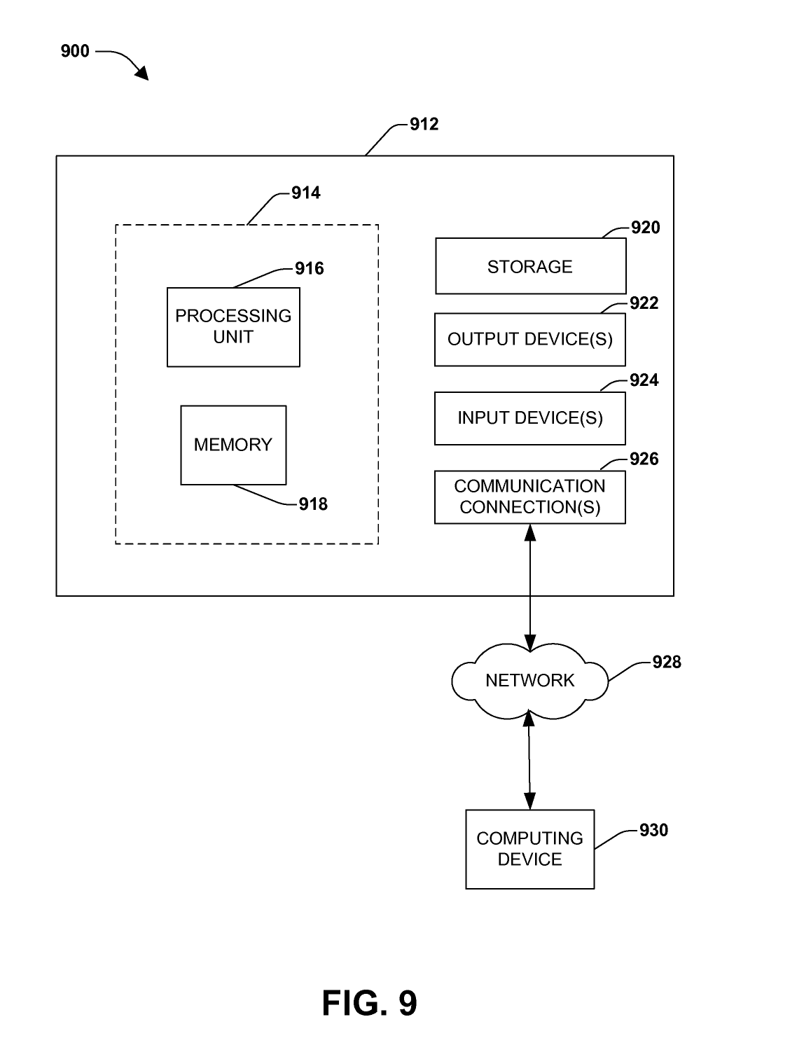

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 900 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Computer storage media does not, however, include propagated signals. Rather, computer storage media excludes propagated signals. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via a network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for providing personalized audio shows, comprising:
identifying content corresponding to an interest of a user;
selecting a natural language template set to apply to the content, the natural language template set defining a first actor template;
utilizing the first actor template to convert a first portion of the content into a first audio snippet;
generating an audio show comprising the first audio snippet; and
providing the audio show to the user.

2. The method of claim 1, comprising:
utilizing a second actor template, defined within the natural language template set, to convert a second portion of the content into a second audio snippet;
generating a dialogue using the first audio snippet and the second audio snippet; and
including the dialogue within the audio show.

3. The method of claim 1, comprising:
evaluating historical travel data for the user to identify an estimated commute time for a current commute of the user; and
selectively adding one or more audio snippets into the audio show based upon the estimated commute time.

4. The method of claim 1, comprising:
evaluating a set of audio samples of a person to generate the first actor template having an audio characteristic of the person.

5. The method of claim 2, comprising:
assigning a first name to a first actor persona, of the first actor template, that is to speak the first audio snippet within the dialogue; and
assigning a second name to a second actor persona, of the second actor template, that is to speak the second audio snippet within the dialogue, the second actor persona referencing the first actor persona using the first name, the first actor persona referencing the second action persona using the second name.

6. The method of claim 1, comprising:
identifying a tone of the content; and
applying an audio characteristic to the first actor template based upon the tone.

7. The method of claim 1, comprising:
generating a video show based upon the audio show; and
providing the video show to the user.

8. The method of claim 7, the generating a video show comprising:
rendering a first actor persona to speak the first audio snippet; and
rendering a second actor persona to speak a second audio snippet corresponding to a second portion of the content.

9. The method of claim 1, the identifying comprising:
evaluating a calendar associated with the user to identify the content.

10. The method of claim 1, the identifying comprising:
evaluating social network data associated with the user to identify the content.

11. The method of claim 1, comprising:
evaluating user interaction of the user with the audio show to generate user feedback; and
adjusting the interest of the user based upon the user feedback.

12. The method of claim 1, the generating an audio show comprising:
identifying second content corresponding to the interest of the user;
utilizing a second actor template, within the natural language template set, to convert the second content into a second audio snippet; and
including the second audio snippet within the audio show.

13. The method of claim 12, comprising:
identifying an audio show playtime for the audio show;
identifying a first playtime of the first audio snippet based upon a first read speed metric of the first actor template;
identifying a second playtime of the second audio snippet based upon a second read speed metric of the second actor template; and
selecting the first audio snippet and the second audio snippet for inclusion within the audio show based upon the first playtime and the second playtime being less than the audio show playtime.

14. The method of claim 1, the content corresponding to a first topic category, and the method comprising:
identifying second content corresponding to a second interest of the user;
utilizing a second actor template, defined within the natural language template set, to convert the second content into a second audio snippet; and
including the second audio snippet within the audio show, the second audio snippet corresponding to a second topic category different than the first topic category.

15. The method of claim 1, comprising:
determining the interest of the user based upon at least one of a social network profile, a user location, web browsing history, a user data file, user demographic data, user cultural data, or a user specified interest.

16. The method of claim 1, the providing the audio show comprising:
playing the audio show through at least one of a videogame console or a vehicle computing device.

17. A system for providing personalized audio shows, comprising:
an audio show generation component configured to:
identify content corresponding to an interest of a user;
select a natural language template set to apply to the content, the natural language template set defining a first actor template and a second actor template;
utilize the first actor template to convert a first portion of the content into a first audio snippet;
utilize the second actor template to convert a second portion of the content into a second audio snippet;
generate an audio show comprising the first audio snippet and the second audio snippet; and
provide the audio show to the user.

18. The system of claim 17, the audio show generation component configured to:
evaluate historical travel data to identify an estimated commute time for a current commute of the user; and
selectively add one or more audio snippets into the audio show based upon the estimated commute time.

19. The system of claim 17, comprising:
a template generator configured to:
evaluate a set of audio samples of a person to generate the first actor template having an audio characteristic of the person.

20. A computer readable medium comprising instructions which when executed perform a method for providing personalized video shows, comprising:
identifying content corresponding to an interest of a user;
selecting a natural language template set to apply to the content, the natural language template set defining a first actor template and a second actor template;
utilizing the first actor template to convert a first portion of the content into a first audio snippet;
utilizing the second actor template to convert a second portion of the content into a second audio snippet;
generating a video show based upon the first audio snippet and the second audio snippet, generating comprising:
rendering a first actor persona to speak the first audio snippet; and
rendering a second actor persona to speak the second audio snippet; and
providing the video show to the user.
